(19) United States
(12) Patent Application Publication
(10) Pub. No.: US 2016/0132609 A1
(43) Pub. Date: May 12, 2016

(54) METHOD FOR PROCESSING TAG, SYSTEM FOR IDENTIFYING TAG, AND RELATED COMMUNICATION TERMINAL

(71) Applicant: YEON TECHNOLOGIES CO., LTD., Taipei City (TW)

(72) Inventor: Bing-Yi Lin, Taipei City (TW)

(73) Assignee: YEON TECHNOLOGIES CO., LTD., Taipei City (TW)

(21) Appl. No.: 14/657,370

(22) Filed: Mar. 13, 2015

Related U.S. Application Data
(60) Provisional application No. 62/076,815, filed on Nov. 7, 2014.

(51) Int. Cl. G06F 17/30; G06K 7/10; G06K 7/14

(52) U.S. Cl. CPC G06F 17/30876; G06K 7/1404; G06K 7/10009; G06F 17/30879

(57) ABSTRACT

A communication terminal includes a camera, a reader, a processor, a memory, and a display. The camera is used for capturing an identification mark, located on a tag, which includes a pattern and an identification code mapping the pattern. The reader is used for reading the identification code. The memory stores program instructions executable by the processor. The program instructions include a determining unit, a first setting unit, and an editing unit. The determining unit is used to determine whether the identification code is stored in the memory. The first setting unit is used to choose a predetermined pattern mapping the identification code, when the identification code is not stored in the communication terminal. The editing unit is used to edit a tag data, which includes an object image or an object name. The display is used for displaying the tag data and the predetermined pattern.

### CROSS REFERENCE TO RELATED APPLICATIONS

This application claims the benefit of U.S. Provisional Application Ser. No. 62/076,815 file Nov. 7, 2014, which is incorporated herein their entirety.

### BACKGROUND OF THE INVENTION

1. Field of the Invention

The present invention relates to instant communication technology, more particularly to a method for processing tags, a system for identifying tags, and a related communication terminal.

2. Description of the Prior Art

As technology improves, more and more enterprises choose digital systems, which are much easier and less costly to upgrade than traditional automatic facilities. Nowadays data from purchase to sales can simply be processed through digital systems, in which “barcode tags” are playing a crucial role.

Barcode tags are typically pasted on items, most frequently used for checking out in supermarkets. Today the use of barcode tags have reduced manpower, improved accuracy, and more importantly, increased efficiency of data transmission, which are made instantly processable, while before may have had taken as long as a month. As a result, barcode tags are now greatly applied in post offices, airports, libraries, and factories, etc., to save and control time.

With all the advantages, however, barcode tags must be equipped with necessary hardware facilities, such as readers and terminals for recording data. That's why the application of barcode tags is still very limited to producer's side, not widely accepted among consumers. For example, it could have been a great idea for consumers to record on barcodes the content of a great pile of house-moving packages, had consumers not need to buy a reader and a terminal in the first place.

Yet the development of instant communication via smart phones has brought upon a solution. With a smart phone at hand, users can easily get online to transmit or read messages and to watch images or videos. This would be the right direction of a new way to process barcode tags.

### SUMMARY OF THE INVENTION

The present invention offers a method for processing tags, a system for identifying tags, and a related communication terminal. Via the communication terminal, users can instantly identify, process, and edit the chosen tag.

According to the present invention, a method for processing data, comprises: scanning with a communication terminal an identification mark, located on a tag, which comprises a pattern, the identification mark having an identification code mapping the pattern; determining whether the identification code is stored in the communication terminal; when the identification code is not stored in the communication terminal, storing the identification code in the communication terminal, and displaying tag data and a predetermined pattern, which is stored in the communication terminal and maps the identification code; and editing with the communication terminal the tag data, comprising an object image or an object name, and storing an edited tag data in the communication terminal.

In one aspect of the present invention, the pattern is a color or a profile of the tag.

In another aspect of the present invention, the identification mark is a barcode or a radio frequency identification (RFID) chip.

In another aspect of the present invention, the method further comprises: displaying the tag data and the predetermined pattern, which is stored in the communication terminal and maps the identification code, when the identification code is already stored in the communication terminal.

In still another aspect of the present invention, the method further comprises: looking up the object image or the object name using the communication terminal; and displaying the predetermined pattern mapping the object image or the object name using the communication terminal.

In yet another aspect of the present invention, the method further comprises: transmitting the identification code and the tag data to a server via a network; and setting an authorization for the tag data in the server using the communication terminal.

According to the present invention, a communication terminal comprises a camera, a reader, a processor, a memory, and a display. The camera is used for capturing an identification mark, located on a tag, which comprises a pattern, the identification mark having an identification code mapping the pattern. The reader is used for reading the identification code. The memory electrically connected to the processor, is used for storing a plurality of program instructions executable by the processor. The plurality of program instructions comprises a determining unit, a first setting unit, and an editing unit. The determining unit is executed by the processor to determine whether the identification code is stored in the memory. The first setting unit is executed by the processor to choose a predetermined pattern mapping the identification code stored in the communication terminal, when the identification code is not stored in the communication terminal. The editing unit executed by the processor is used to edit a tag data, which comprises an object image or an object name. The display is used for displaying the tag data and the predetermined pattern, which is stored in the communication terminal and maps the identification code.

In one aspect of the present invention, the pattern is a color or a profile of the tag.

In another aspect of the present invention, the plurality of program instructions further comprise: a searching unit executed by the processor, for looking up the tag data mapping the object image or the object name; and the display shows the predetermined pattern mapping the object image or the object name.

In still another aspect of the present invention, the plurality of program instructions further comprise a transmitting unit executed by the processor to transmit the identification code and the tag data to a server via a network, and a second setting unit executed by the processor to set an authorization for the tag data in the server.

In yet another aspect of the present invention, the identification mark is a barcode or a radio frequency identification (RFID) chip, when read by the reader, the determining unit executed by the processor determines whether the identification code is stored in the memory.

According to the present invention, a tag identification system comprises a first communication terminal, a server, and a second communication terminal. The first communication terminal is used for capturing pattern of a tag and setting tag data, and for transmitting via a network to a server the pattern of the tag, an identification code mapping the pattern of the tag, and the tag data, which comprises an object image or an object name. The server is used for storing the pattern of the tag and the tag data. The second communication terminal is used for downloading the pattern of the tag, the tag data, and the identification code, for searching in the server the tag mapping the object image or the object name, or for reading the identification code to search the tag mapping the identification code.

In one aspect of the present invention, the first communication terminal sets an authorization of the tag data in the second communication terminal via the server.

In another aspect of the present invention, the second communication terminal edits the object image or the object name mapping the tag stored in the server.

In still another aspect of the present invention, the pattern of the tag is a color or a profile of the tag.

According to the present invention, a method for processing data comprises: scanning with a communication terminal an identification mark, located on a tag, which comprises a pattern and an identification code mapping the pattern; determining whether the identification code is stored in the communication terminal; displaying the tag data and the predetermined pattern, which is stored in the communication terminal and maps the identification code, when the identification code is already stored in the communication terminal; and editing with the communication terminal the tag data, comprising an object image or an object name, and storing an edited tag data in the communication terminal.

In one aspect of the present invention, the pattern is a color or a profile of the tag.

In another aspect of the present invention, the identification mark is a barcode or a radio frequency identification (RFID) chip.

In still another aspect of the present invention, the method further comprises: looking up the object image or the object name using the communication terminal; and displaying the predetermined pattern mapping the object image or the object name using the communication terminal.

In yet another aspect of the present invention, the method further comprises: transmitting the identification code and the tag data to a server via a network; and setting an authorization for the tag data in the server using the communication terminal.

In contrast to prior art, the present invention, via the method for processing tags and the system for identifying tags, allows an instant display and editability on the communication terminal of an object image or an object name, after the communication terminal scans a pattern or an identification code of a tag. Therefore, there is no need for users to buy additional readers or terminals to record tag data anymore. Sole usage of the present invention's communication terminal will do, bringing efficiency to the job of editing and searching tag data. Furthermore, the present invention allows co-editing and co-searching of the same group of tags among users of different communication terminals, bringing great convenience to data management.

These and other features, aspects and advantages of the present disclosure will become understood with reference to the following description, appended claims and accompanying figures.

### BRIEF DESCRIPTION OF THE DRAWINGS

FIG. 1 illustrates a schematic diagram of a tag identifying system according to a preferred embodiment of the present invention.

FIG. 2 illustrates a schematic diagram of the tag according to a preferred embodiment of the present invention.

FIG. 3 illustrating a flow chart of a method for processing tag data according to a first embodiment of the present invention.

FIG. 4A shows the first communication terminal display states in response to respective scans of the tags.

FIG. 4B shows the first communication terminal display states in response to respective scans of the tags after re-editing or modifying the data of the tags.

FIG. 5 illustrates a flow chart of a method for processing tag data according to a second embodiment of the present invention.

FIG. 6 illustrates a tag according to another preferred embodiment of the present invention.

### DETAILED DESCRIPTION OF THE PREFERRED EMBODIMENTS

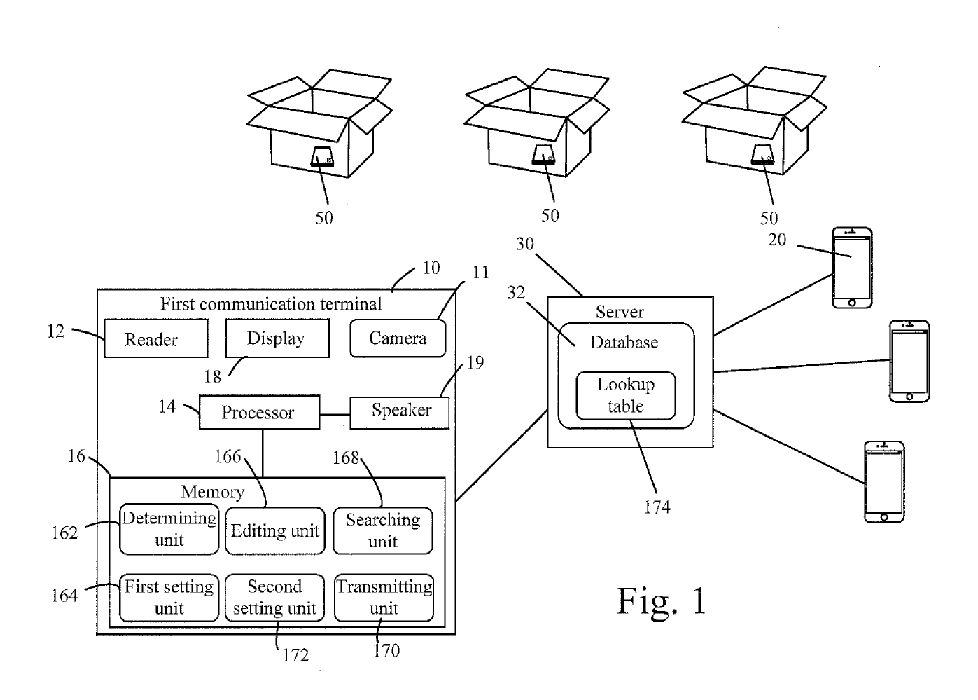

Please refer to FIG. 1 illustrating a schematic diagram of a tag identifying system 1 according to a preferred embodiment of the present invention. The tag identifying system 1 comprises a plurality of communication terminals, a plurality of tags 50, and a server 30. The plurality of communication terminals can be handheld electronic devices, such as smart phones or tablets, communicating with the server 30 through a network. The plurality of communication terminals have the same hardware structure and functional rules, so in order to enhance explanation, in the following embodiments a first communication terminal 10 and a second communication terminal 20 are chosen for description. The other communication terminals can all be the first communication terminal 10 or the second communication terminal 20. Also, in order to enhance illustration, FIG. 1 shows only the structure of the first communication terminal 10, without showing that of the second communication terminal 20.

The first communication terminal 10 comprises: a camera 11, a reader 12, a processor 14, a memory 16, a display 18, and a speaker 19. The first communication terminal downloads from the server 30 a plurality of program instructions and stores them in the memory 16. The memory 16 electrically connects to the processor 14. The plurality of program instructions comprise: a determining unit 162, a first setting unit 164, an editing unit 166, a searching unit 168, a transmitting unit 170, and a second setting unit 172. The following embodiments shall describe in detail all the functions, executed by the processor 14, of the determining unit 162, the first setting unit 164, the editing unit 166, the searching unit 168, the transmitting unit 170, and the second setting unit 172. The server 30 stores a database 32, whose lookup table 174 records the relation of the plurality of the tags 50.

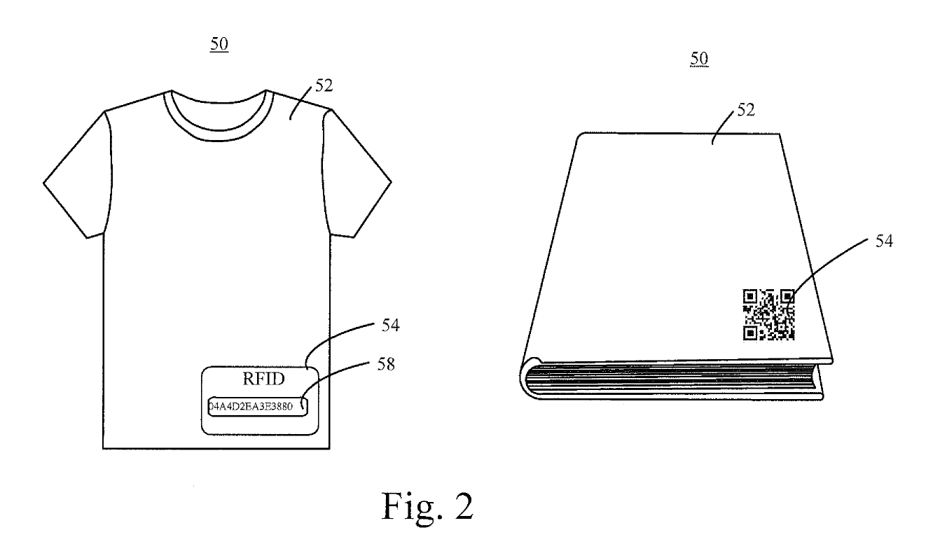

Please refer to FIG. 2 illustrating a schematic diagram of the tag 50 according to a preferred embodiment of the present invention. The tag 50 comprises a pattern 52, which can be a shape of all sorts of items such as books, clothes, animals, food, or can be a color of different gray levels such as red, green, blue, yellow, and white. The tag 50 further comprises an identification mark 54, which can be a barcode or a radio frequency identification (RFID) chip or both of these. The RFID chip is not easy to be damaged with time passing. The barcode can be a 2-dimension (2D) barcode or a QR code. Preferably, each of the tags 50 maps each of the barcodes or the RFID chips one by one. Namely, each of the identification marks 54 of the tags 50 has a unique identification code 58, e.g. 04A4D2EA3E3880. When the identification codes 58 of each of the barcodes or chips are different, each of the identification codes 58 still has a unique mapping to each of the tags 50. The identification mark 54 of each of the tags 50 maps the identification code 58 of pattern 52 of each of the tags 50. Please note that since each of the tags 50 has a unique identification code 58, multiple tags 50 with the same pattern 52 will not be seen as the same tags 50. When each of the tags 50 is made, the relation of its pattern 52, identification mark 54, and identification code 58 is stored in the lookup table 174 in the database 32 of the server 30, for identification purchases. At this stage, the pattern 52, the identification mark 54, and the identification code 58 map one another one by one.

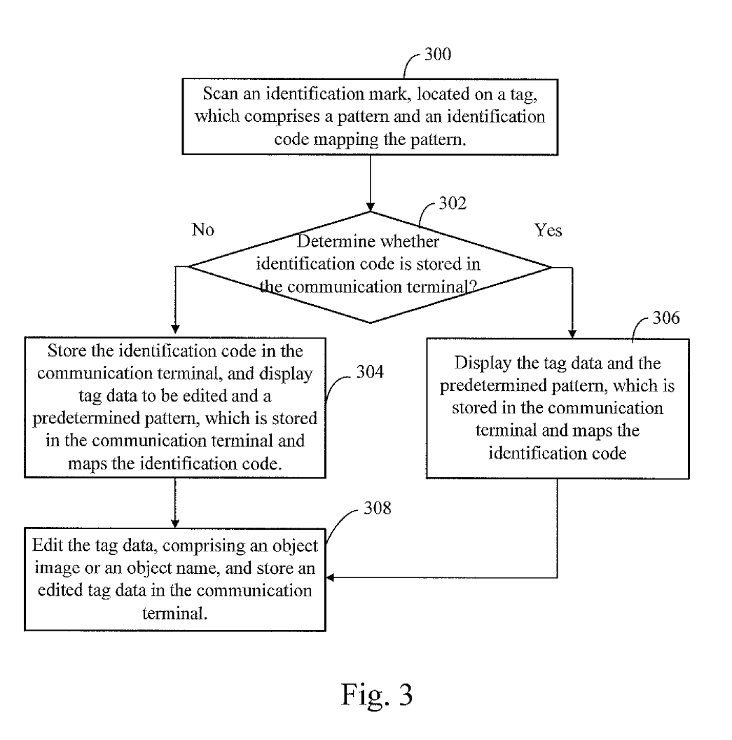

Please refer to FIG. 3 illustrating a flow chart of a method for processing tag data according to a first embodiment of the present invention, comprising the following steps:

Step 300: The communication terminal 10 is used to scan the identification mark 54 located on the tag 50. The tag 50 comprises the pattern 52, which is mapped by the identification code 58 of the identification mark 54.

Step 302: The communication terminal 10 determines whether the identification code 58 is stored in the communication terminal 10.

Step 304: When the identification code 58 is determined to be not stored in the communication terminal 10, the communication terminal 10 stores the identification code 58, chooses the predetermined pattern 52, which is stored in the communication terminal 10 and maps the identification code 58, and displays the pattern 52 as well as data to be edited of the tag 50.

Step 306: When the identification code 58 is determined to be stored in the communication terminal 10, the communication terminal 10 displays the predetermined pattern 52 and the data of the tag 50, which is stored in the communication terminal 10 and maps the identification code 58.

Step 308: The communication terminal 10 is used to edit data of the tag 50, which comprises an object image or an object name, and stores the data edited.

Please refer to FIG. 1 to FIG. 3. In Step 300, when the first communication terminal 10 is used to scan the tag 50, whose pattern 52, with the shape of a book for instance, can either be captured by the camera 11, or be scanned of its identification mark 54 by the reader 12 to read the identification code 58. Preferably, the reader 12 is a near field communication (NFC) reader. In this step, if the first communication terminal 10 has no program for the processing data, the first communication terminal 10 would download the database 32 of the server 30, the lookup table 174 of the relation of pattern 52, the identification mark 54, and the identification code 58, and stores the lookup table 174 in the memory 16 via a network.

In Step 302, the determining unit 162 is used to determine whether the identification code 58 is stored in the lookup table 174 in the memory 16.

In Step 304, since the identification code 58 is not stored in the memory 16, it's the first time for the tag 50 to be read by the communication terminal 10. The first setting unit 164 then searches the predetermined pattern 52 mapping the identification code 58 from the lookup table 174 in the memory 16. Also, the display 18 of the first communication terminal 10 displays the predetermined pattern 52 and the data to be edited of the tag 50.

In Step 306, since the identification code 58 is stored in the communication terminal 10, it means that the tag 50 is read by the communication terminal 10 once again. The first setting unit 164 then searches the predetermined pattern 52 mapping the identification code 58 from the lookup table 174 in the memory 16. Also, the display 18 of the communication terminal 10 displays the predetermined pattern 52 and the data of the tag 50, which is stored in the communication terminal 10 and maps the identification code 58.

In Step 308, the communication terminal 10 is used to edit data of the tag 50 via the editing unit 166, and to store the edited data into the memory 16. The data of the tag 50 comprises an object image or an object name. In detail, the first communication terminal 10 can capture multiple object images and store the images via the editing unit 166 into a folder mapping the tag 50 and afterwards, edit or rename the images. The data of the tag 50 may further comprise addressee information and so on. Users may re-edit the data of the tag 50 via the editing unit 166.

For example, before packaging for moving, users can photograph recipes A1-A3, magazines B1-B4, and comic books C1-C6 as object images PA1-PA3, PB1-PB4, and PC1-PC6, respectively. Next, put the recipes A1-A3, the magazines B1-B4, and the comic books C1-C6 into three respect boxes, and paste respectively tags 50a-50c with patterns 52 in the shape of a book. After using the first communication terminal 10 to scan the identification mark 54 of the tag 50a or to photograph the pattern 52 of the tag 50a (Step 300), the determining unit 162 determines that the identification code 58 of tag 50a is not stored in the lookup table 174 in the memory 16, since the tag 50a is read by the communication terminal 10 for the first time (Step 302). Then the first setting unit 164 finds in the lookup table 174 that the predetermined pattern 52 mapping the tag 50a is in the shape of a book. At the moment, the display 18 displays the book pattern and a folder of the tag 50a (Step 304). Next, as depicted in Step 308, users, by using input devices such as buttons or a touch screen of the first communication terminal 10, control the editing unit 166 to store the object images PA1-PA3 into the folder of the tag 50a, or to edit an object list of the recipes A1-A3 and store the object list into the folder of the tag 50a, or to name the folder of the tag 50a as “Recipe.” Likewise, users can store the object images PB1-PB4 into the folder of the tag 50b, or to edit an object list of the magazines B1-B4 and store the object list into the folder of the tag 50b, or to name the folder of the tag 50b as “Magazine;” and can store the object images PC1-PC6 into the folder of the tag 50c, or to edit an object list of the comics books C1-C6 and store the object list into the folder of the tag 50c, or to name the folder of the tag 50c as “Comic Books.” Via the procedure depicted above, users can easily put different kinds of objects in separate boxes, each pasted a tag 50 with pattern 52 in different shapes.

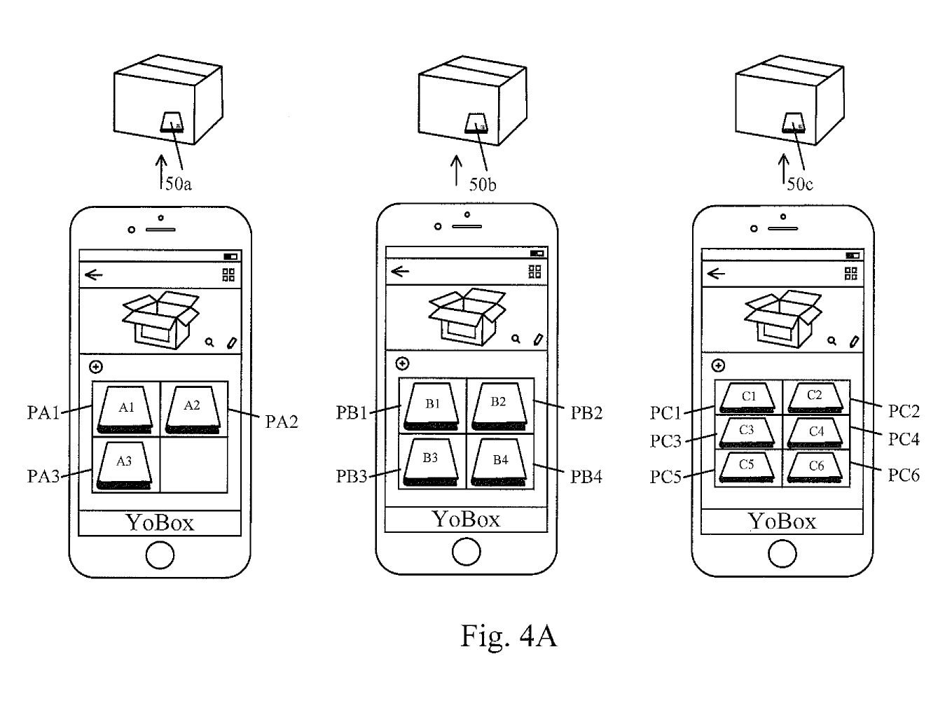

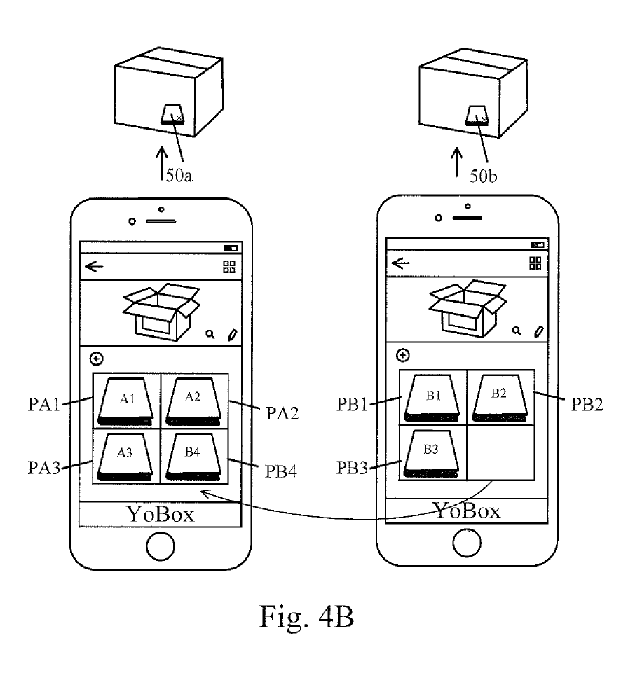

Please refer to FIG. 4A showing the first communication terminal 10 display states in response to respective scans of the tags 50a-50c. The first communication terminal 10 further comprises a searching unit 168. The searching unit 168 is used for searching the tag data mapping the object image or the object name. Now continue with the moving example, the user, after arriving at the destination, wants to locate the comic book C6. By using the searching unit 168 to search with the object image PC6 or with the name of the comic book C6, the comic book C6 can be located to be in the box which is pasted with the tag 50c. Since the patterns 52 of the tags 50a-50e are all in the shape of a book, the user now can target the boxes pasted with the tags 50a-50c. Then, by using the first communication terminal 10, photograph the patterns 52 of the tags 50a-50c, or scan the identification code 58 of the tags 50a-50c. In response to a scan of the tag 50a pasted on the box, the display 18 displays the folder of the tag 50a and the contained object images PA1-PA3 or the object list of the recipes A1-A3, so that the user knows immediately that the comic book C6 is not in the box pasted with the tag 50a. In response to a scan of the tag 50c pasted on the box, the display 18 displays the folder of the tag 50c and the contained object images PC1-PC6 or the object list of the comic books C1-C6, so that the user knows immediately that the comic book C6 is in the box pasted with the tag 50c.

Furthermore, the searching unit 168 is capable of searching with the identification code 58 to find the mapping tag 50.

Preferably, when the object image or the object name searched by the searching unit 168 maps the tag data stored, the speaker of the first communication terminal 10 alarms. As in the moving example, in response to the scan of the tag 50c pasted on the box, not only the display 18 displays the folder of the tag 50c and the contained object images PC1-PC6 or the object list of the comic books C1-C6, but the speaker 19 also alarms, so that the user knows immediately that the comic book C6 is in the box pasted with the tag 50c.

Please refer to FIG. 4B showing the first communication terminal 10 display states in response to respective scans of the tags 50a-50c after re-editing or modifying the data of the tags 50. The user may re-edit or modify the data of the tags 50. Now continue with the moving example, if the user changes his mind to move the magazine B4 from the box pasted with the tag 50b to the box pasted with the tag 50a, and to categorize the magazine B4 as “Recipe,” he can use the input device (i.e. buttons or the touch screen of the communication terminal 10) to select and hold the object image PB4 displayed on the display 18 in response to the scan of the tag 50b. Then, through the editing unit 166, move the object image PB4 into the folder of tag 50a when the display 18 shows the folder of the tag 50a and the contained object images PA1-PA3 in response to the scan of the tag 50a. In this way, it is convenient for the user to modify the data of the tags 50 upon the scan of the desired tags 50.

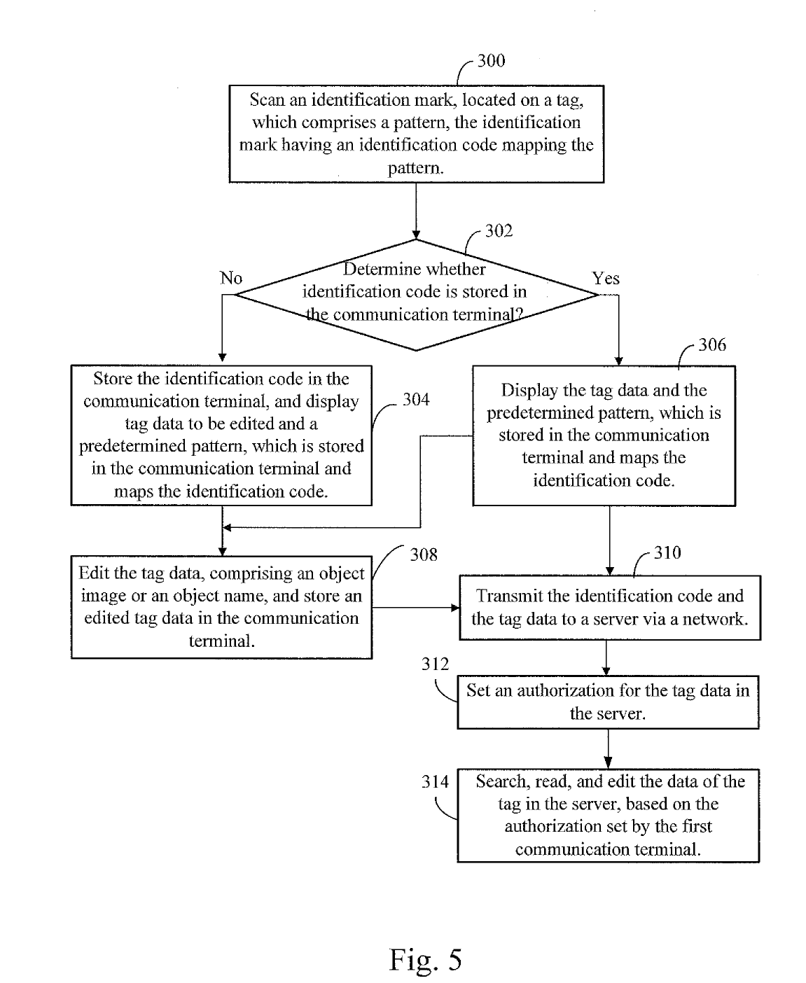

Please refer to FIG. 5 illustrating a flow chart of a method for processing tag data according to a second embodiment of the present invention, comprising the following steps:

Step 300: The communication terminal 10 is used to scan the identification mark 54 located on the tag 50. The tag 50 comprises the pattern 52, which is mapped by the identification code 58 of the identification mark 54.

Step 302: The communication terminal 10 determines whether the identification code 58 is stored in the communication terminal 10.

Step 304: When the identification code 58 is determined to be not stored in the communication terminal 10, the communication terminal 10 stores the identification code 58, chooses the predetermined pattern 52, which is stored in the communication terminal 10 and maps the identification code 58, and displays the pattern 52 as well as data to be edited of the tag 50.

Step 306: When the identification code 58 is determined to be stored in the communication terminal 10, the communication terminal 10 displays the predetermined pattern 52 and the data of the tag 50, which is stored in the communication terminal 10 and maps the identification code 58.

Step 308: The communication terminal 10 is used to edit data of the tag 50, which comprises an object image or an object name, and stores the data edited.

Step 310: The first communication terminal 10 transmits via a network the identification code 58 and the data of the tag 50 to the server 30.

Step 312: The first communication terminal 10 sets an authorization for the tag data 50 in the server 30.

Step 314: The second communication terminal 20 searches, reads, downloads, and edits the data of the tag 50 in the server 30, based on the authorization set by the first communication terminal 10.

Please refer to both FIG. 1 and FIG. 5. Since the Steps 300-308 illustrated in FIG. 5 are the same as in FIG. 3, those in FIG. 3 will not be discussed hereinafter. The first communication terminal 10 further comprises the transmitting unit 170 and the second setting unit 172. In Step 310, after capturing the pattern 52 of the tag 50 and setting the data of the tag 50, the first communication terminal 10 can transmit via the transmitting unit 170 the pattern 52 of the tag 50, the data of the tag 50, and the identification code 58 mapping the tag 50 to the server 30. The lookup table 174 in the database 32 of the server 30 records the relation of the pattern 52 of the tag 50, the data of the tag 50, and the identification code 58 mapping the tag 50. Each time after the data of the tag 50 is updated, the first communication terminal 10 can then decide whether to update the lookup table 174. Or, the database 32 of the server 30 periodically updates the lookup table 174 edited by the first communication terminal 10.

The transmitting unit 172 of the first communication terminal 10 is also capable of transmitting the encrypted data of the tag 50 to the second communication terminal 20.

In Step 312, the first communication terminal 10 sets an authorization for the tag data 50 in the server 30 via the second setting unit 172. That is, the first communication terminal 10 can decide via the setting unit 172 whether the second communication terminal 20 can read or edit the lookup table 174 in the database 32 of the server 30. The first communication terminal can also allow via the setting unit 172 the second communication terminal 20 to search and read, but not to edit the data of the tag 50 in the database 32. Finally, the first communication terminal can allow as well via the setting unit 172 the second communication terminal 20 to add or edit the data of the tag 50 in the database 32, i.e. to edit the object image or the object name mapping the tag 50 in the database 32.

Specifically, a user D1 uses the first communication terminal 10 to photograph the patterns 52 of the tags 50 and transmits via a network to server 30 the patterns 52 of the tags 50, the data of the tags 50, and the identification codes 58 mapping the tags 50. Next, the user D1 mails the boxes pasted with the tags 50 to a user D2. Then the user D1 sets via the second setting unit 172 of the first communication terminal 10 an authorization to allow the second communication terminal 20 to download, search, read, and edit the data of the tags 50 in the database 32 of the server 30. In Step 314, the user D2 can use the second communication terminal 20 to search in the server 30 with the object image or the object name to target the mapping tag 50, or to read the identification code 58 to search the mapping tag 50.

In the above embodiment of the user D1 and D2, the first communication terminal 10 and the second communication terminal 20 can download a plurality of program instructions from the server 30 and store them into the memory 16. Then the processor 14 executes the plurality of program instructions to perform the functions of each unit. In another embodiment, the first communication terminal 10 and the second communication terminal 20 can also access via the network the plurality of program instructions in the server 30 to log in the server 30, so being able to search and manage the data of the tags 50 in the database 32.

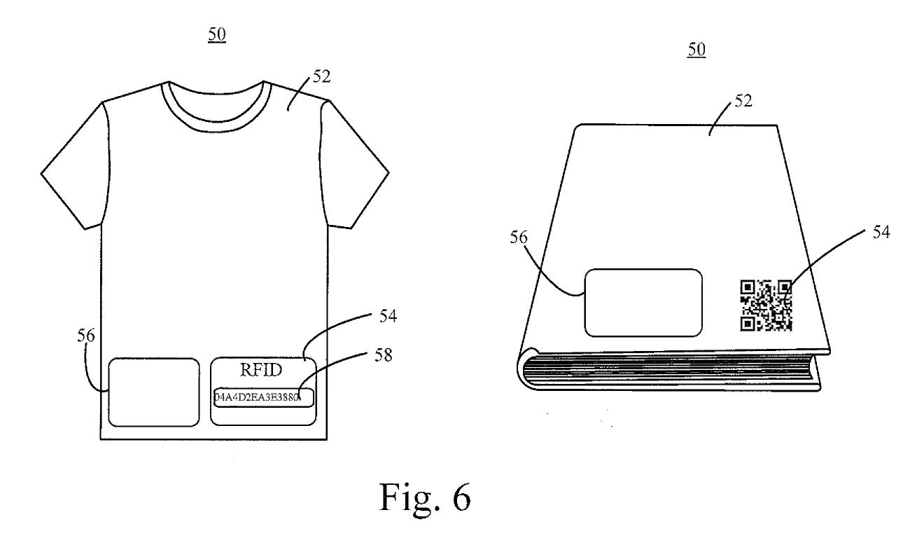

Please refer to FIG. 6 illustrating a tag 50 according to another preferred embodiment of the present invention. Besides an identification mark 54, the tag 50 further comprises an editing area 56, where users can drawn their own pattern or write text, not limited to the original pattern 52 of the tag 50. After the editing area 56 of each of the tags 50 is edited, the edited content in the editing area 56, along with the relation of the identification mark 54 and the identification code 58, can also be uploaded to the database 32 of the server 30. Now the content in the editing area 56 replaces the original pattern 52 of the tag 50. Therefore, the content in the editing area 56, the identification mark 54, and the identification code 58 have a one to one mapping relation.

To maintain the security of the tag 50, once the tag 50 is pasted on a box, the identification mark 54 (i.e. the barcode or the RFID chip) is destroyed upon the removal of the tag 50 off the box. Once the identification mark 54 is destroyed, the tag 50 shall remain invalid even if the pattern 52 of the tag 50 or the content in the editing area 56 can still be identified by the communication terminals.

Consequently, the present invention, via the method for processing tags and the system for identifying tags, allows an instant display and editability on the communication terminal of an object image or an object name, after the communication terminal scans a pattern or an identification code of a tag. Therefore, there is no need for users to buy additional readers or terminals to record tag data anymore. Sole usage of the present invention's communication terminal will do, bringing efficiency to the job of editing and searching tag data. Furthermore, the present invention allows co-editing and co-searching of the same group of tags among users of different communication terminals, bringing great convenience to data management.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

1. A method for processing data, comprising:
scanning with a communication terminal an identification mark, located on a tag, which comprises a pattern, the identification mark having an identification code mapping the pattern;
determining whether the identification code is stored in the communication terminal;
when the identification code is not stored in the communication terminal, storing the identification code in the communication terminal, and displaying tag data and a predetermined pattern, which is stored in the communication terminal and maps the identification code, and the redetermined pattern is the same as the pattern of the tag; and
editing with the communication terminal the tag data, comprising an object image or an object name, and storing an edited tag data in the communication terminal.

2. The method of claim 1, wherein the pattern is a color or a profile of the tag.

3. The method of claim 1, wherein the identification mark is a barcode or a radio frequency identification (RFID) chip.

4. The method of claim 1, further comprising:
displaying the tag data and the predetermined pattern, which is stored in the communication terminal and maps the identification code, when the identification code is already stored in the communication terminal.

5. The method of claim 1, further comprising:
looking up the object image or the object name using the communication terminal; and
displaying the predetermined pattern mapping the object image or the object name using the communication terminal.

6. The method of claim 1, further comprising:
transmitting the identification code and the tag data to a server via a network; and
setting an authorization for the tag data in the server using the communication terminal.

7. A communication terminal, comprising:
a camera, for capturing an identification mark, located on a tag, which comprises a pattern, the identification mark having an identification code mapping the pattern;
a reader, for reading the identification code;
a processor;
a memory electrically connected to the processor, for storing a plurality of program instructions executable by the processor, and the plurality of program instructions comprising:
a determining unit, configured to cause the processor to determine whether the identification code is stored in the memory;
a first setting unit, configured to cause the processor to choose a predetermined pattern mapping the identification code stored in the communication terminal, when the identification code is not stored in the communication terminal; and
an editing unit, configured to cause the processor to edit a tag data, which comprises an object image or an object name; and
a display, for displaying the tag data and the predetermined pattern, which is stored in the communication terminal and maps the identification code,
wherein the predetermined pattern is the same as the pattern of the tag.

8. The communication terminal of claim 7, wherein the pattern is a color or a profile of the tag.

9. The communication terminal of claim 7, wherein the plurality of program instructions further comprise: a searching unit configured to cause the processor to look up the tag data mapping the object image or the object name; and the display shows the predetermined pattern mapping the object image or the object name.

10. The communication terminal of claim 7, wherein the plurality of program instructions further comprise:
a transmitting unit, configured to cause the processor to transmit the identification code and the tag data to a server via a network; and
a second setting unit, configured to cause the processor to set an authorization for the tag data in the server.

11. The communication terminal of claim 7, wherein the identification mark is a barcode or a radio frequency identification (RFID) chip, when read by the reader, the determining unit executed by the processor determines whether the identification code is stored in the memory.

12. A tag identification system, comprising:
a first communication terminal, for capturing pattern of a tag and setting tag data, and for transmitting via a network to a server the pattern of the tag, an identification code mapping the pattern of the tag, and the tag data, which comprises an object image or an object name;
the server, for storing the pattern of the tag and the tag data, and storing a predetermined pattern which is the same as the pattern of the tag; and
a second communication terminal, for downloading the pattern of the tag, the tag data, and the identification code if the pattern of the tag matches the predetermined pattern, for searching in the server the tag mapping the object image or the object name, or for reading the identification code to search the tag mapping the identification code.

13. The tag identification system of claim 12, wherein the first communication terminal sets an authorization of the tag data in the second communication terminal via the server.

14. The tag identification system of claim 12, wherein the second communication terminal edits the object image or the object name mapping the tag stored in the server.

15. The tag identification system of claim 12, wherein the pattern of the tag is a color or a profile of the tag.

16. A method for processing data, comprising:
scanning with a communication terminal an identification mark, located on a tag, which comprises a pattern and an identification code mapping the pattern;
determining whether the identification code is stored in the communication terminal;
displaying the tag data and a predetermined pattern, which is stored in the communication terminal and maps the identification code, when the identification code is already stored in the communication terminal, and the predetermined pattern is the same as the pattern of the tag; and
editing with the communication terminal the tag data, comprising an object image or an object name, and storing an edited tag data in the communication terminal.

17. The method of claim 16, wherein the pattern is a color or a profile of the tag.

18. The method of claim 16, wherein the identification mark is a barcode or a radio frequency identification (RFID) chip.

19. The method of claim 16, further comprising:
looking up the object image or the object name using the communication terminal; and
displaying the predetermined pattern mapping the object image or the object name using the communication terminal.

20. The method of claim 16, further comprising:
transmitting the identification code and the tag data to a server via a network; and
setting an authorization for the tag data in the server using the communication terminal.
